(19) United States
(12) Patent Application Publication
(10) Pub. No.: US 2012/0255476 A1
(43) Pub. Date: Oct. 11, 2012

(54) Decorative covers

(76) Inventors: Maxine Walker Walker, Las Vegas, NV (US); Connie Marie Russell Russell, Las Vegas, NV (US)

(21) Appl. No.: 13/066,071

(22) Filed: Apr. 6, 2011

(51) Int. Cl. E06B 9/386; B23P 19/04; D05B 23/00

(52) U.S. Cl. 112/407; 112/475.08; 29/24.5; 112/408

(57) ABSTRACT

“Decorative Covers” provide consumers with an easy and efficient method for changing the look of vertical Venetian blinds (5) five different ways in a distinct design. The invention is comprised of two separate swatches of cloth material, each of which bears a different color and/or design. These swatches are elongated strip format and in same proportionate sizes to match the Venetian blind slat to which they are to encase. These swatches are attached by stitch on each elongated vertical side and on one horizontal border remains an open proximal end is an open horizontal slit, and on each wall, and through which the attachment pieces of the encased Venetian blind slat fit. The interior border of this proximal end may be lined with a hook-and-loop, buttonhole, snaps and/or straps upon encased Venetian Blind slat. The sleeve may be removed and machine washed. The sleeves are available in a wide variety of colors and designs.

### SPECIFIC, UNIQUE FUNCTION OR PROPERTY OF INVENTION

“Decorative Covers” provide a new and individualized decorative theme to decorative common home decorating elements.

“Decorative Covers” are decorated sleeves into which the individual slats of Venetian blinds may be inserted, and with different decorative patterns and/or colors on each side that can be used in five (5) different ways.

“Decorative Covers” feature cloth material in the format of an elongated sleeve with one (1) closed distal end, and different patterns and/or colors on each lateral side of this sleeve.

The proximal end of the “Decorative Covers” features horizontal slits to accommodate the attachment points of the encased blind, and swatches of hook-and-loop, button hole, snaps or straps to secure the “Decorative Covers” upon the blind which encases.

“Decorative Covers” encase the individual slats of Venetian blinds.

“Decorative Covers” add a new format of decoration to those traditional elements of household decor.

“Decorative Covers” enhance the appearance of its using environment.

“Decorative Covers” offer five (5) different decor-enhancing elements in each single unit.

Each wall of “Decorative Covers” carries a separate color and/or design.

“Decorative Covers” allow users to instantly change the appearance of the environment of use just by rotating the Venetian blind slats or by sliding the sleeves off an applying the sleeves on to receive the appearance of (5) different ways.

“Decorative Covers” allow users to quickly change the appearance of the using environment to match particular seasons and holidays.

“Decorative Covers” allow users to quickly change appearance of the environment of use to cater to particular moods and desires.

“Decorative Covers” allow users to quickly change the aura about their environment of use.

“Decorative Covers” allow users to change the appearance of their environment of use from formal to casual and vice versa, and simply by rotating the Venetian blinds or the appearance of (5) different ways.

“Decorative Covers” allow users to change the appearance of their environment of use from summer to winter and vice versa, and simply by rotating the Venetian blinds or the appearance of (5) different ways.

“Decorative Covers” can make very old damage Venetian blinds appear brand new.

“Decorative Covers” can eliminate the high cost of replacing old and/or damage Venetian blinds.

“Decorative Covers” provide an inexpensive way to renovate the appearance of its using environment.

“Decorative Covers” are very easy to apply.

“Decorative Covers” provide users with a very inexpensive method of redecorating the environment of use.

“Decorative Covers” provide users with a very simply method of redecorating the environment of use.

“Decorative Covers” can gather positive attention from the visitors to its environment of use.

“Decorative Covers” can provide this inexpensive and easy to apply redecorating tool to both private homes and commercial environment.

“Decorative Covers” can be made in sponsored formats, such as by use for sports team's logos.

“Decorative Covers” can be made in variations for commercial use, in which would they bear the logos and/or emblems of their environment of use.

“Decorative Covers” can be made in various sizes for applications upon Venetian blinds of various sizes.

“Decorative Covers” can be made in variations for application upon horizontal slat blinds.

“Decorative Covers” can be package in kits along with variation of the product designed to be placed over items such as but not limited to valances, table place mats, napkins, couch covers, pillows, bed skirts and comforters.

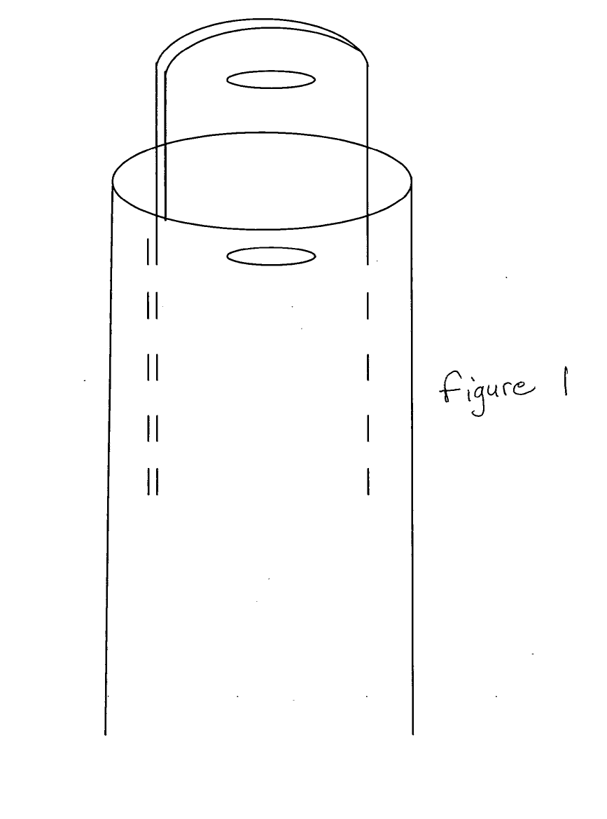

FIG. 1) Vertical blind encase in window blind cover.

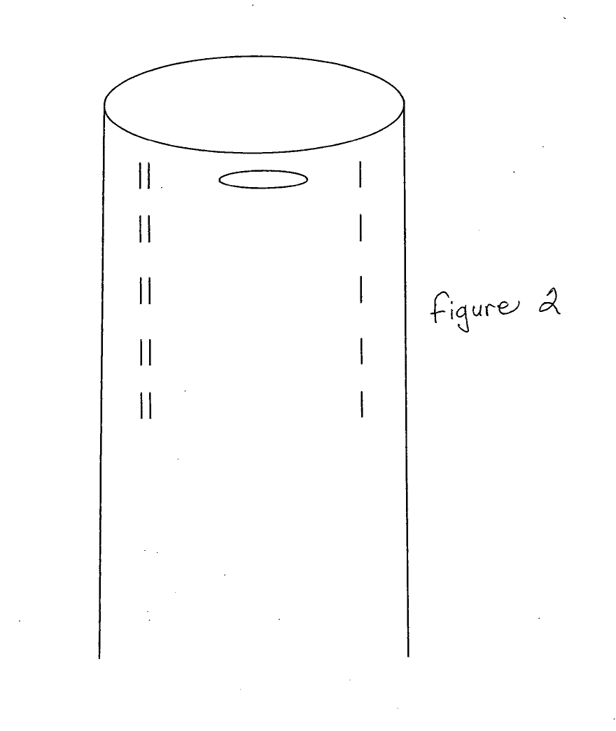

FIG. 2) Window blind cover with buttonhole or other securities can be used such as snaps, hook and loop and straps.

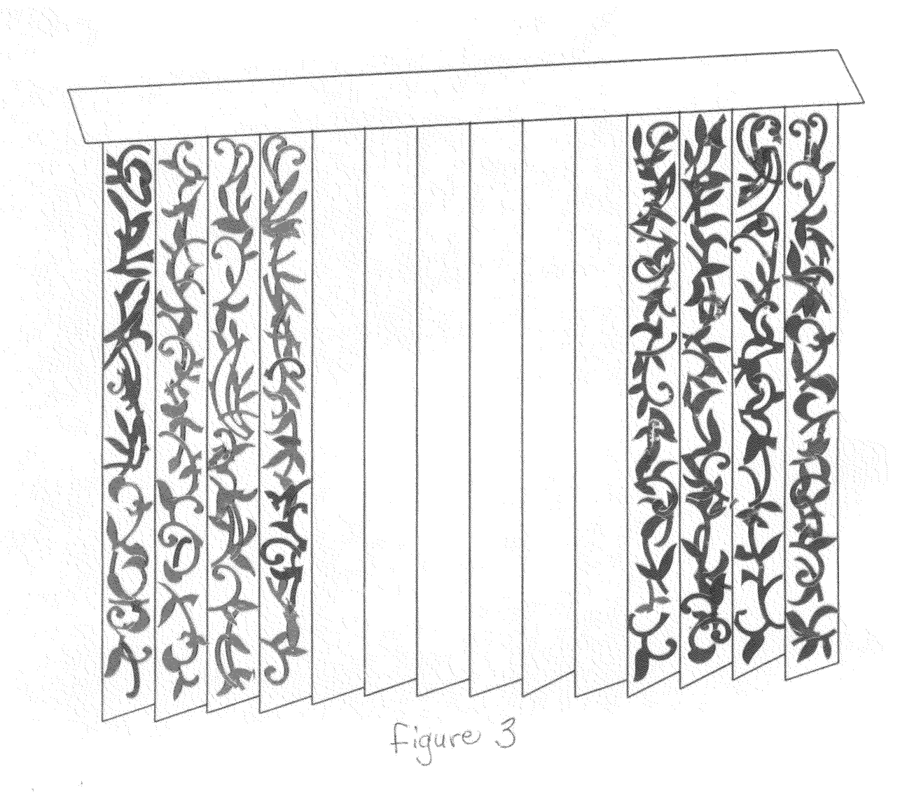

FIG. 3) Show's how the window blind covers, may be placed to show design on outside.

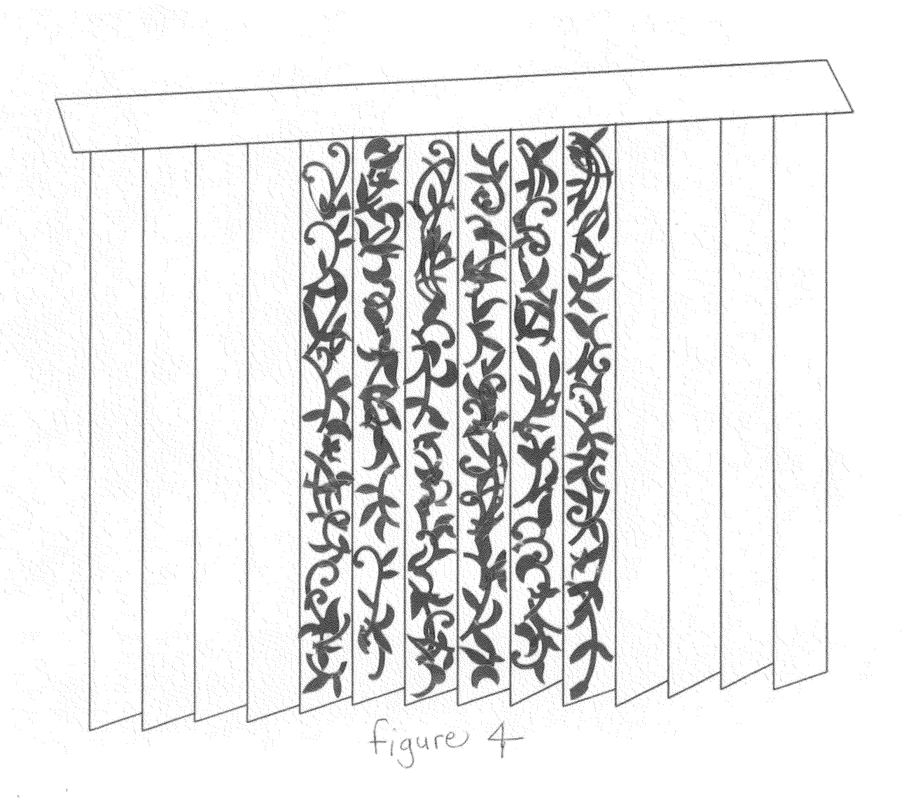

FIG. 4) Show's how the window blind covers may be placed to show design on inside.

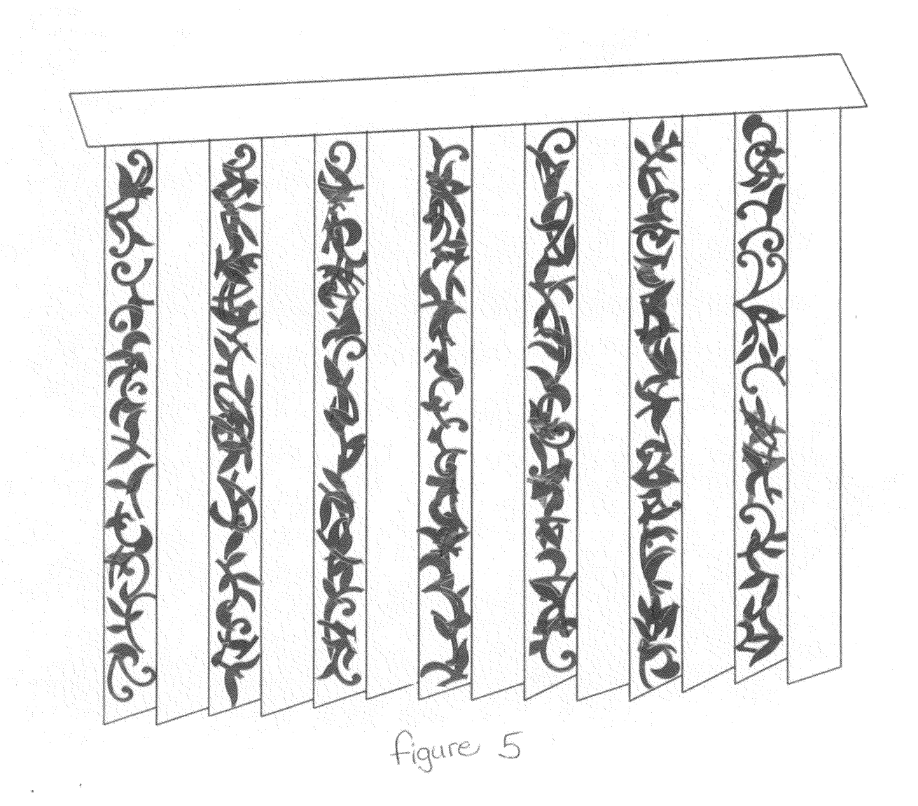

FIG. 5) Show's how the window blind covers may be placed in a design pattern every other encases.

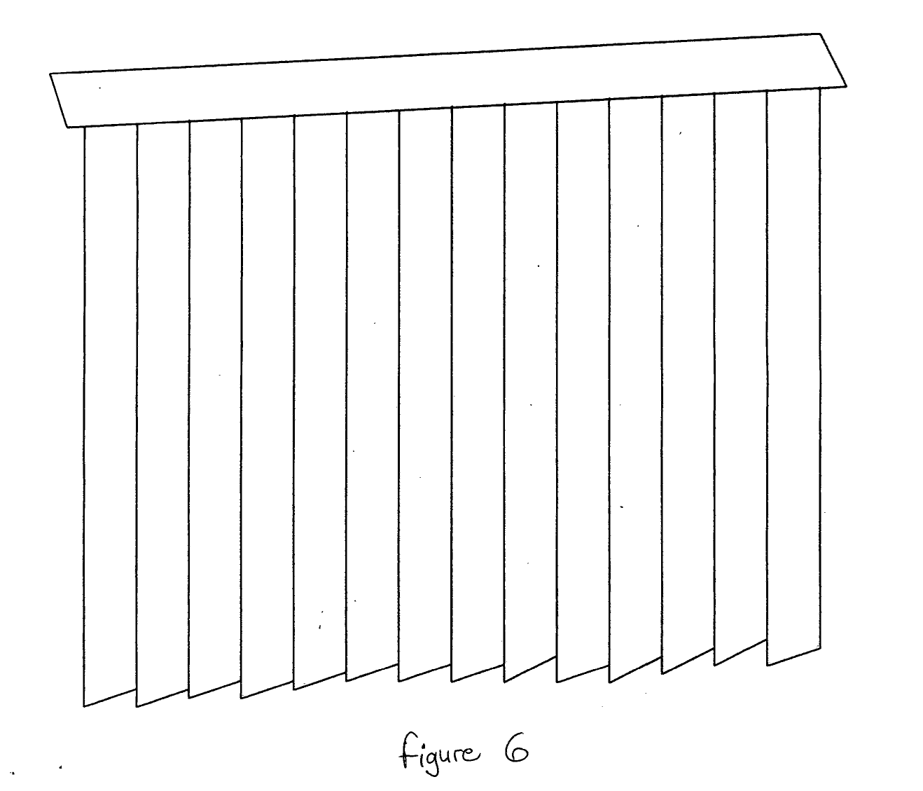

FIG. 6) Show's how the sleeve change to a solid colored print background fabric.

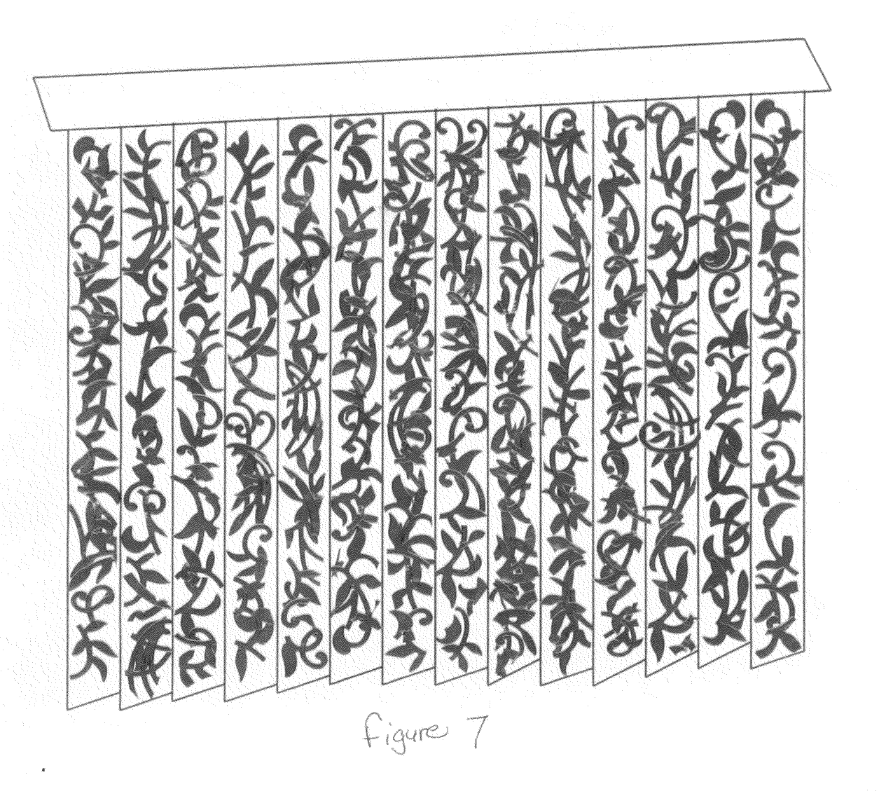

FIG. 7) Show's how the sleeve changes to an all print fabric background.

Having described the instant invention as in the foregoing, I claim:

1. A method of change the decor of a window blind arrangement in (5) five different ways.
a) Window blind covering are made of two (2) separate swatches of cloth material, each which bears a different color and/or design.
b) These swatches are in elongated strip format, and in same proportion sizes to match the Venetian blind slat to which they are to encase.
c) These swatches are attached by stitch on each elongated vertical side and on one (1) horizontal border. The opposite horizontal border remains an open proximal end of the window blind covering
d) Right below the border of this open proximal end is an open horizontal slit, and on each wall, and through which the attachment pieces of the encased Venetian blind slat fit.
e) The interior border of this proximal end is lined with a hook-and-loop, button hole, snaps or straps for securement of the window blind covering upon the encased Venetian blind slat.

2. Whenever the user desires a notable change in decor as described in claim 1, he or she may simply rotate the Venetian blinds to reveal the opposite and different side or detach the blinds cover to appear in (5) different ways as described in claim 1.

3. Window blind covering can be made in various sizes for application upon Venetian blinds of various sizes, as described in claim 1.

4. Window blind covering can be made in variations in which its open proximal end is intended for the bottom end of the blind slat. In such variation, the distal end would be at the top point of the blind slat, and this distal end would include apertures at each sidewall for alignment with the attachment points of the encased blind as described in claim 3.

5. Window blind covering as described in claim 1, can be made of various materials,

6. Window blind covering as described in claim 1, can be made in various colors, design and patterns.

7. Window blind covering as described in claim 1, can be made in variations that feature only one (1) color, design and/or pattern for both sides.

8. The sleeve is configured having a tub body having defined front and back only one (1) color, design and/or pattern for both sides as described in claim 7.

9. “Decorative Covers” allow users to change the appearance of their environment of use from summer to winter and vice versa, and simply by rotating the Venetian blinds or the appearance of (5) different ways, as described in claim 1.

10. “Decorative Covers” allow users to quickly change the aura about their environment of use as described in claim 9.

11. “Decorative Covers” allow users to change the appearance of their environment of use from formal to casual and vice versa, and simply by rotating the Venetian blinds or the appearance of (5) different ways as described in claim 9.

12. “Decorative Covers” allow users to quickly change the appearance of the using environment to match particular seasons and holidays as described in claim 9.

13. “Decorative Covers” allow users to quickly change appearance of the environment of use to cater to particular moods and desires as described in claim 9.
